(19) United States
(12) Patent Application Publication
(10) Pub. No.: US 2022/0397128 A1
(43) Pub. Date: Dec. 15, 2022

(54) WORKING CYLINDER AND METHOD FOR THE PRODUCTION THEREOF

(71) Applicant: Buemach Engineering International B.V., TA Emmen (NL)

(72) Inventor: Josef Bueter, Haren/Altenberge (DE)

(21) Appl. No.: 17/775,436

(22) PCT Filed: Nov. 6, 2020
(86) PCT No.: PCT/DE2020/000267

§ 371 Date: May 9, 2022

(30) Foreign Application Priority Data
Nov. 8, 2019 (DE) 10 2019 007 754.7

(51) Int. Cl. F15B 15/14; F16J 10/02; B23K 26/282

(52) U.S. Cl. CPC F15B 15/1428; F15B 15/1438; F16J 10/02; B23K 26/282

(57) ABSTRACT

A working cylinder has a cylinder tube, a first closure part, a second closure part and a piston unit. The first closure part is arranged on a first cylinder tube end, the second closure part is arranged on a second cylinder tube end to define a cylinder interior. The piston unit defines at least one working chamber in the cylinder interior. The piston unit slides through the first closure part. The first closure part is joined to the cylinder tube by a first peripheral laser ring weld seam and the second closure part is joined to the cylinder tube by a second peripheral laser ring weld seam. The laser ring weld seams each define a fluid-tight sealing plane. A method for producing the working cylinder is provided.

The invention relates to a welded working cylinder and a method for the production thereof.

Working cylinders as such are known from the state of the art. The working cylinders may be, in particular, differential working cylinders, plunger cylinders, synchronized cylinders or telescopic cylinders.

A differential working cylinder, for example, is a double-acting hydraulic working cylinder with two working chambers, wherein in the two working chambers the effective surfaces of the piston have different sizes. Thus, forces of different magnitudes act on the piston in the two actuation directions at the same operating pressure. In contrast to a differential working cylinder, the piston rod of a synchronized cylinder is guided by guide closure parts arranged on both sides so that the effective surfaces of the piston are of the same size and, consequently, forces of the same magnitude act in both actuation directions at the same operating pressure so that synchronized cylinders are used in particular as steering cylinders. A plunger cylinder, in contrast, is a single-acting working cylinder in which the pressure medium displaces the piston as a solid body and thus causes it to move outwards. The same applies to the telescopic cylinder, in which several cylinder tubes are inserted into each other, thus enabling particularly long working movements.

All such working cylinders comprise a cylinder tube and closure parts.

According to the state of the art, such working cylinders are usually produced by screwing the closure parts to the cylinder tube. Therefore, these working cylinders are also referred to as screw cylinders in the prior art.

Furthermore, it is known from the state of the art to connect the bottom closure part to the cylinder tube by MAG welding and then only to screw the guide closure part.

The thread of the cylinder tube and closure parts is usually produced by a machining process.

Both screw cylinders and cylinders with screw connection of only one closure part and MAG welding of the other closure part are provided in high quality according to the state of the art and have proven to be first-class and reliable products.

From the view of production, it must be noted that, especially for the cylinder tube, an allowance of the material thickness, i.e., the tube wall thickness, must be provided for the thread to be subtractively produced because the thread inevitably weakens the cylinder tube. However, this allowance results in a tube wall thickness that is considerably overdimensioned for the absorption of the forces during operation, the forces caused by the operating pressure of the fluid in particular. This leads disadvantageously to increased material consumption and an increased final weight of the differential working cylinder.

As a disadvantage, the machining processes for producing the thread also require a high degree of precision and are therefore very demanding in the production.

Furthermore, an additional seal must regularly be inserted between the cylinder tube and the respective closure part in order to achieve the tightness of the cylinders.

In addition, the final assembly requires a lot of time and skilled labour.

It is also a disadvantage that additional means must be provided to avoid the loosening of the screw connection. Finally, it is disadvantageous that, as a result of the changing operating pressures, the threads are subject to dynamic loads which limit their service life.

It is the task of the invention to provide a working cylinder which is of particularly high quality and can be produced in a material-saving, simple and thus cost-effective manner. Furthermore, it is the task of the invention to disclose a cost-effective method for the production of such a working cylinder.

With reference to the working cylinder, the task is solved by the features indicated in claim 1, and with reference to the production method by the features indicated in claim 10. Preferred further embodiments result from the respective sub-claims.

According to the invention, the working cylinder comprises a cylinder tube, a first and a second closure part and a piston unit. The first closure part and the second closure part are hereinafter collectively also referred to as the closure parts.

The working cylinder according to the invention produced from these basic components may be provided in different designs. In particular, the working cylinder can be a differential working cylinder, a plunger cylinder, a synchronized cylinder, a telescopic cylinder, a traction cylinder or also a pneumatic working cylinder. If the working cylinder is designed as a synchronized cylinder, it will hereinafter also be referred to as a steering cylinder. Working cylinders within the meaning of the present invention are further understood to be, in particular, storage cylinders, gas spring cylinders and hydraulic shock absorbers.

The cylinder tube has a hollow-cylindrical design in a manner known per se and, according to the invention, comprises a first cylinder tube end and a second cylinder tube end. After assembly, the first closure part is arranged at the first cylinder tube end and the second closure part is arranged at the second cylinder tube end. Preferably, both cylinder tube ends are manufactured in the same way. Thus, the two cylinder tube ends preferably have bevelled axial front face sides, wherein the bevels have the same angle. Consequently, the axial front face sides preferably have the same cross-sectional area.

However, it is also possible to manufacture differentially designed cylinder tube ends.

According to the invention, the first closure part is arranged at the first cylinder tube end. Preferably, the first closure part is a guide closure part. A guide closure part is understood to be a closure part which receives a piston unit in a sliding and sealing manner. In a differential working cylinder, for example, the piston unit can consist of a piston and a piston rod, and the piston rod is received by the guide closure part. In a plunger cylinder, the piston unit is designed as a volume-forming piston, also referred to as a plunger piston, which is received by the guide closure part.

The first closure part is designed such that it has a contact surface which, when attached to the first cylinder tube end, rests against a corresponding further contact surface of the first cylinder tube end. These contact surfaces preferably surround the first closure part and the cylinder tube completely. This results in a continuous annular surface against which the first closure part at the first cylinder tube end rests. If the annular surface is obliquely inclined, it is a truncated cone lateral surface from a geometric point of view. For the sake of simplicity and irrespective of the geometric design, this surface hereinafter simply referred to as an annular surface.

According to the invention, the second closure part is arranged at the second cylinder tube end. The contents of the description concerning the relationship of the first closure part to the first cylinder tube end apply correspondingly to the relationship of the second closure part to the second cylinder tube end. With regard to the contact surface, the second closure part is designed analogously to the first closure part. Preferably, the second closure part is a bottom closure part, which is then axially opposite the piston of the piston unit and axially delimits the at least one working chamber of the working cylinder according to the invention.

The working cylinder according to the invention further comprises the piston unit. Depending on the type of working cylinder, the piston unit can consist of a piston and a piston rod—which is the case, for example, with a differential working cylinder or a synchronized cylinder—or only of a piston—which is the case, for example, with a plunger cylinder—or it can have other designs. If the piston unit comprises a piston and a piston rod, the piston and the piston rod have a fixed positional relationship relative to each another. Preferably, the piston and the piston rod are firmly coupled to each other. In such designs, they are preferably connected in a material-bonding (integrally connected) manner by welding. The piston and piston rod can also be detachably coupled. In special cases, however, it is also possible that the piston unit is designed as a one-piece unit and, thus, the piston and piston rod are sections of a monolithic component.

In the assembled state, the cylinder tube and the closure parts form a cylinder interior according to the invention. If the cylinder tube and closure parts are joined together, their inside surface sections delimit the cylinder interior. And the cylinder interior extends to the respective laser ring weld seam.

Furthermore, in the working cylinder according to the invention, the piston unit forms at least one working chamber in the cylinder interior. This chamber is defined by the cylinder tube, a closure part and the piston unit. The piston unit is arranged such that it can be axially displaced, and the main longitudinal axis of the cylinder tube and the axial direction of movement of the piston unit coincide. In this design, the piston unit preferably passes, at least in sections, through the first closure part in a sliding and sealing manner. A pressure medium connection is assigned to the working chamber via which the pressure medium can enter the working chamber or be led out of it and, thus, the working chamber can be pressurized. The pressure medium can be a hydraulic or pneumatic pressure medium.

If the working cylinder according to the invention is, for example, designed as a differential working cylinder, the following applies in addition.

The piston of the piston unit is arranged in the cylinder interior and separates the cylinder interior into a piston crown working chamber, hereinafter also abbreviated to piston crown chamber, and a piston rod working chamber. The piston crown chamber is located between the piston and the second closure part, here designed as a bottom closure part. The piston rod working chamber is located on the side of the piston rod between the piston and the first closure part, here designed as a guide closure part. The at least one working chamber is thus the piston rod working chamber. In addition, the piston crown working chamber forms a further working chamber.

The piston can be axially displaced and arranged in the cylinder interior in such a way that the main longitudinal axes of the piston and cylinder tube overlap each other.

The pressure medium connections are provided at the cylinder such that an operating pressure can be applied to the piston crown working chamber and the piston rod working chamber.

The piston may additionally have various guide, sealing or piston rings. Various embodiments of a piston for a working cylinder are known as such from the state of the art.

According to the invention, the piston rod slidably passes through the first closure part, here designed as a guide closure part.

The piston rod is slidably supported in the guide closure part, and the guide closure part is designed such that it prevents the pressure medium, hereinafter also referred to as a fluid, from escaping. This is achieved, for example, by appropriate ring seals.

The working cylinder according to the invention is particularly characterized in that both closure parts, i.e., for example both the guide closure part and the bottom closure part in the case of a differential working cylinder, are welded to the cylinder tube.

In this case, the first closure part is joined to the cylinder tube by means of a first circumferential (peripheral) laser ring weld seam and the second closure part is joined to the cylinder tube by means of a second circumferential laser ring weld seam. Hereinafter, the components connected to each other are also referred to collectively as the coupling partners.

The two closure parts are joined to the cylinder tube by laser welding. The laser ring weld seams are fusion welded joints produced without the addition of filler metals.

Advantageously, laser welding forms a very narrow, tapered weld seam. The acute angle formed by the lateral flanks of the essentially V-shaped laser weld seam is preferably less than 15 degrees and in a particularly preferred design less than 10 degrees.

The two laser ring weld seams each form a fluid-tight sealing plane. This means that the first laser ring weld seam prevents the pressure medium from passing the connection point between the cylinder tube and the first closure part, and the second ring weld seams prevents the pressure medium passage between the cylinder tube and the second closure part, and all this without the need for additional sealing means, such as a sealing ring.

The cylinder tube and closure parts as well as preferably also the piston unit each are made of a metal alloy and, particularly preferably, of a steel alloy. However, the material composition of the individual components may differ slightly. Preferably, the mass proportions of the components of the metal alloy of the cylinder differ from those of the closure parts by less than 10 weight percent. Thus, the closure parts and the cylinder tube have similar physical properties and can be welded together particularly well.

The steel alloy preferably used has a carbon content of less than 0.5 weight percent. The alloy components vanadium, chromium and manganese are preferably contained separately or in combination in a proportion from 0.01 to 2 weight percent.

The welded working cylinder according to the invention has a number of considerable advantages compared to working cylinders of the prior art.

A first significant advantage is that in particular the cylinder tube requires little or no machining apart from cutting to length. In particular, threads have not to be cut or grooves to be turned. In the case of a welded piston unit, this advantage also applies to the piston rod.

This has the direct advantage that the otherwise necessary amount of time, processing machines, tool costs and energy for machining can be saved.

Furthermore, there is the advantage of drastic material savings and thus the preservation of raw material resources because the cylinder tube has to have only about half the tube wall thickness of a screwed differential working cylinder. Allowances, for example in the tube wall thickness to compensate for the material removal for a cut thread, can be omitted.

By the omission of machining the cylinder tube and preferably also the piston rod, the quality is also significantly increased. As a result of the omission of the force input due to machining, the axial concentricity is no longer impaired. Rather, the axial concentricity of the starting products for the cylinder tubes and, if applicable, also of the piston rods is completely maintained. Consequently, the working cylinder according to the invention has a higher precision. Thus, the axial piston rod movement can also be provided without the problem of buckling of the piston rods in the end stop, which is known in the prior art. At the same time, this reduces the wear of the cylinder guides in the guide closure part. By the omission of machining the cylinder tube and, if applicable, the piston rod, reductions in the load capacity due to notch effects are also avoided.

Another advantage is the absolute tightness of the differential working cylinder at the connection points between the cylinder tube and the closure parts. In this respect, it is additionally advantageous that the tightness can be achieved without the seals otherwise required according to the state of the art. The possible omission of these components, which are prone to ageing, results not only in cost savings but also in an improvement in quality and an increase in service life. Moreover, contamination due to ageing seals is excluded.

A further advantage is the increased operational safety. An axial play between the cylinder tube and the closure parts during load changes and loosening, as it is the case with threads, are excluded. Moreover, savings resulting from the omission of otherwise necessary securing elements are advantageously achieved. Finally, the otherwise necessary securing of the actual securing elements required for detachable connections is also omitted. According to the prior art, such securing is obtained, for example, by gluing the securing elements. The omission of gluing leads to further important advantages. Firstly, the costs for the very expensive screw locking adhesives are eliminated. Secondly, there is no need to clean the surfaces to ensure their adhesion to the screw locking adhesives, which, according to the state of the art, often requires cleaning chemicals that are hazardous to health. This eliminates the need for special measures to ensure health protection and environmental protection. Thirdly, the problem that detachable connections, even when secured by screw locking adhesives, can be subject to the risk of loosening under impact loads is overcome.

Another aspect of increased operational safety is the increased resistance to manipulation. Non-destructive interventions in the cylinder interior are excluded. Possible sources of injury in connection with improper opening or improper reassembly of a differential working cylinder by untrained personnel are eliminated.

The laser welding process only leads to highly locally restricted heating of the material in the area of the laser ring weld seams.

Thus, components with thermally sensitive materials, such as seals in particular, which would be damaged by other welding processes, can still be welded just a few millimetres to the planned weld seam.

Also, scaling on the inner surface sections of the cylinder tube and the closure parts, particularly in the vicinity of the weld seams, which would otherwise occur has to be removed with great effort according to the state of the art, is avoided.

Another advantage is the reduction of thermal stresses in the coupling partners of the welded joint, since only a relatively small amount of energy input per unit length (amount of energy related to the length of the weld seam) has to be supplied in the case of laser welding.

Another advantage is that the contour, the weld seam depth and the angle of the laser ring weld seams can be determined to a large extent by the movement, the energy input per unit length and the angle of the laser beam relative to the working cylinder to be produced. Thus, the contour and angle can be specifically aligned by changing the position of the laser relative to the coupling partners.

In a first particularly preferred embodiment of the working cylinder according to the invention, the working cylinder is provided as a double-acting working cylinder and designed as a differential working cylinder.

In this embodiment, the first closure part is designed as a guide closure part and the second closure part is designed as a bottom closure part. Therefore, the first cylinder tube end is referred to as the guide-side cylinder tube end and the second cylinder tube end is referred to as the bottom-side cylinder tube end herein. Thus, the first laser ring weld seam is arranged between the guide closure part and the guide-side cylinder tube end, and the second laser ring weld seam is arranged between the bottom closure part and the bottom-side cylinder tube end.

In a differential working cylinder, the piston unit comprises a piston and a piston rod. With regard to the structure of the piston unit designed in this way, reference is made to the above contents of the description of the working cylinder.

The piston of the piston unit is arranged in the cylinder interior and thus separates the cylinder interior into a piston crown working chamber, hereinafter also abbreviated to piston crown chamber, and a piston rod working chamber, also abbreviated to piston rod chamber. The effective area of the piston in the piston crown chamber is greater on the piston crown side of the piston than on the piston rod chamber side of the piston. Thus, a greater force acts on the piston on the piston crown side than on the piston rod side at the same pressure of the pressure medium. A force acting on the piston is transmitted from the cylinder interior to the outside by means of the piston rod, which slidably passes through the guide closure part for this purpose.

In a second particularly preferred embodiment of the working cylinder according to the invention, the working cylinder is also provided as a double-acting working cylinder; however, in this embodiment it is designed as a synchronized cylinder.

In the synchronized cylinder according to this advantageous further development, the first closure part is designed as a guide closure part, as it is the case for a differential working cylinder. In addition, and as a special feature, the second closure part is also designed as a further guide closure part. The guide closure part and the further guide closure part are hereinafter collectively also referred to as the guide closure parts. Thus, the first laser ring weld seam is arranged between the guide closure part and the first cylinder tube end, and the second laser ring weld seam is arranged between the further guide closure part and the second cylinder tube end.

In this design, the piston unit also comprises a piston and a piston rod. The piston is arranged in the cylinder interior and separates it into a first and a second piston rod working chamber. For this purpose, the piston rod projects axially over the piston on both sides and is guided out of the piston interior on both sides through the closure parts, which are both provided as guide closure parts here. Thus, the piston rod slidably passes through both guide closure parts.

Both piston rod working chambers have the same cross-section and thus the piston has the same effective target surfaces for the pressure medium on both sides The force acting on the piston and the length of the working stroke executed by the piston are the same in each case, regardless of whether a certain pressure flow of the pressure medium, which is the same in terms of pressure and volume, acts on the first or the second piston rod working chamber. Due to this identical behaviour in both actuation directions, the synchronized cylinder is often also used as a steering cylinder and is therefore also referred to as a steering cylinder.

According to another further development, the working cylinder is designed as a plunger cylinder. This is a single-acting working cylinder.

According to this further development, the first closure part is designed as a guide closure part and the second closure part is designed as a bottom closure part. The first cylinder tube end is a guide-side cylinder tube end and the second cylinder tube end is a bottom-side cylinder tube end. As it is the case with a differential working cylinder, the first laser ring weld seam is thus arranged between the guide closure part and the guide-side cylinder tube end, and the second laser ring weld seam is thus arranged between the bottom closure part and the bottom-side cylinder tube end.

The piston unit of the plunger cylinder is formed by a plunger piston. The plunger is arranged in the cylinder interior. Only one working chamber is formed in the cylinder interior. The plunger piston slidably passes through the guide closure part. When a pressure flow of the pressure medium is applied to the working chamber, the plunger is axially displaced correspondingly to the introduced volume of the pressure flow and performs an outward movement. The inward movement is caused by a force acting from the outside in the opposite direction.

According to an advantageous further development, the working cylinder is characterized in that a first circumferential sealing ring is arranged in the cylinder interior between the first closure part and a cylinder tube inner wall of the cylinder tube at its first cylinder tube end at an axial distance from the first laser ring weld seam, said first circumferential sealing ring forming a first pressure-separated annular section, which is arranged between the first circumferential sealing ring and the first laser ring weld seam and/or in that a second circumferential sealing ring is arranged in the cylinder interior between the second closure part and a cylinder tube inner wall of the cylinder tube at its second cylinder tube end at an axial distance from the second laser ring weld seam, said second circumferential sealing ring forming a second pressure-separated annular section which is arranged between the second circumferential sealing ring and the second laser ring weld seam.

That means that according to this further development, a circumferential sealing ring is integrated upstream of at least one laser ring weld seam. Preferably, a circumferential sealing ring is arranged upstream of both laser ring weld seams. Hereinafter, the circumferential sealing ring is also referred to as an O-ring.

In the cylinder interior, the O-ring separates an annular section in front of the respective laser ring weld seam from the rest of the cylinder interior in a pressure-tight manner. It was surprisingly found that by the forming of a laser ring weld seam, the energy input per unit length can be set so low that a thermally sensitive O-ring is not damaged even in close vicinity to the laser ring weld seam. Close vicinity is understood to be an axial distance between the laser ring weld seam and the O-ring that is smaller than an internal cylinder tube diameter. The O-ring causes the separation of the annular section from the working pressure of the pressure medium. Thus, an axial section of the cylinder tube directly in front of and at the laser ring weld seam is not subject to the working pressure of the pressure medium from the inside and is therefore not subject to buckling load. In this way, a radial load on the laser ring weld seam, which would otherwise occur, is simultaneously avoided in an advantageous manner by a very simple means. Instead, only the axial load is applied. The axial load is based on the working pressure of the pressure medium acting on the base area of the respective closure part. Thus, a multi-axial load on the laser ring weld seam and consequentially a multi-axial material stress there are advantageously avoided.

At the same time, the upstream O-ring protects the at least one working chamber or, depending on the type of working cylinder with O-rings on both sides, both working chambers from contamination. Any emissions occurring during laser welding or particles that could detach from the coupling partners in the area of the laser weld seam are retained in the respective annular section by the O-ring before entering the working chamber.

According to another advantageous further development, the laser ring weld seams have a laser ring weld seam depth which has a ratio of 1.1 to 2.5 relative to a cylinder tube wall thickness.

If the laser ring weld does not run perpendicular through the cylinder tube wall, the laser ring weld seam depth is greater than the thickness of the cylinder tube wall.

Thus, the connection between the closure parts has a particularly advantageous higher stability, as the force transmission in the weld seam is distributed over a larger area and is therefore optimized.

This results in the further advantage that the tube wall thickness of the cylinder tube can even be more reduced for specific applications.

In addition, according to this advantageous further development, it is also possible to make the laser ring weld seam depth greater than the cylinder tube wall thickness, even with a substantially vertical alignment of the weld seam, by introducing the laser ring weld seam deeper into the closure part than the cylinder tube is thick. This results in a deeper weld seam root. Preferably, the laser ring weld depth is at least 1.2 times the cylinder tube thickness. It was surprisingly found that the structural changes in the closure part caused in this way increase the load-bearing capacity of the ring weld seams.

According to a further advantageous further development, the laser ring weld seams have an inclined laser ring weld seam center axis.

According to the same advantageous further embodiment, the laser ring weld seam center axis and a main longitudinal axis of the cylinder tube include a laser ring weld inclination angle alpha, wherein alpha is between 20 and 70 degrees.

The laser ring weld seam center axis extends centrally through the laser ring weld seam and divides the cross-section thereof into equal parts. If the laser ring weld seam center axis is extended up to the main cylinder tube longitudinal axis, which runs centrally and along the cylinder tube, it and the main longitudinal axis form an angle. This angle is the laser ring weld seam inclination angle alpha.

The laser ring weld seam inclination angle alpha is between 20 and 70 degrees so that the laser ring weld seam depth is produced with a ratio of 1.1 to 2.5 relative to the cylinder tube wall thickness.

Thanks to the greater laser ring weld seam depth and the obliquely inclined ring weld seam center axis, the forces are better distributed during a load due to the angle and the area of application of the attacking forces.

According to a further advantageous further development, at least one closure part has an axially opening, circumferential concave receiving contour in which the cylinder tube engages, wherein the receiving contour radially overlaps the cylinder tube and the ring weld seam inclination angle alpha is 110 to 160 degrees. This oblique inclination exceeding 90 degrees is hereinafter also referred to as negative-obliquely inclined.

In the corresponding closure part, the axially opening, circumferential concave receiving contour is provided by an annular groove which has radial side walls. The radially arranged outer side wall is inclined and has a conical shape. Thus, the concave receiving contour forms a radial overlap. The radially arranged inner side wall is preferably not inclined and preferably has a cylindrical shape. So, the cross-section of the receiving contour preferably corresponds to a concave wedge. The cylinder tube is formed at the corresponding cylinder tube end such that it corresponds to the receiving contour and has an oblique annular surface relative to it, the angle of which corresponds to the inclination angle of the outer radial side wall of the receiving contour. The cross-section of the wall of the cylinder tube end thus preferably corresponds to a wedge that fits into the receiving contour.

The laser ring weld seam is arranged between the described inclined annular surfaces of the receiving contour and the cylinder tube. The inclination angle of the laser ring weld seam corresponds to the inclination angle of the two inclined annular surfaces.

It was found that through this further development, three advantageous effects are simultaneously achieved with the same means. Firstly, the radial overlap of the cylinder tube provides positive-locking absorption of buckling forces caused by the working pressure of the pressure medium. The positive-locking absorption of the radially acting buckling forces relieves the laser ring weld seam so that the material-bonding force transmission at the laser ring weld seam is practically exclusively available for axial forces. Secondly, due to the inclination, a ring weld seam depth which exceeds the cylinder tube wall thickness and thus enables a higher force transmission is achieved without additional measures. Thirdly, an assembly advantage is achieved simultaneously, as the cylinder tube and the respective closure part center themselves automatically during an axial feed motion.

According to another advantageous further development, at least one of the laser ring weld seams is arranged axially on the front face side, and the ring weld seam inclination angle alpha is 180 degrees.

Thus, the laser ring weld seam has a cylindrical shape and hence it is arranged radially between the cylinder tube and the respective closure part.

This further development has the particular advantage that the annular front face side of the cylinder tube does not require any special machining. Rather, only the edge of the inner lateral surface of the cylinder tube forms the contact surface to the respective closure part and consequently the surface to be welded for the laser ring weld seam. Furthermore, the respective closure part can advantageously be formed without a radial step. The outer diameter of the closure part only has to correspond to the inner diameter of the cylinder tube, which results in considerable material savings. In addition, little precision is required when forming the length of the cylinder tube, since the exact distance between the two closure parts can be precisely adjusted during joining.

According to another advantageous further development, the inclination angle of the ring weld seam is 90 degrees. From the production view, this further development has the advantage that the annular front face side formed by cutting the length of the cylinder tube can already be used as the contact surface to the respective closure part without any further work steps.

In general, the various advantageous further developments of the formation of the laser ring weld seams are not limited to specific cylinder types. In addition, different designs of the laser ring weld seams can also be combined for one and the same working cylinder.

According to the invention, the process for producing a working cylinder comprises the following process steps:
a) joining the cylinder tube, the first closure part, the second closure part and the piston unit to form a pre-assembly group;
b) establishing a fixed positional relationship of the cylinder tube, the first closure part and the second closure part relative to each other;
c) performing laser welding of the cylinder tube to the first closure part by producing the first laser ring weld seam and to the second closure part by producing the second laser ring weld seam.

In process step a), the cylinder tube, both closure parts and the piston unit are arranged in their end position. Hereinafter, the components arranged in this way are referred to as the pre-assembly group.

Thus, the piston unit is put into the first closure part and inserted into the cylinder tube.

The first closure part is added to the first cylinder tube end and the second closure part to the second cylinder tube end.

In a preferred solution, all components are pre-assembled. This means that temperature-sensitive components such as the seal and the guide are also inserted in the first closure part, which is designed as a guide closure part. The same applies to the guide and seal on the piston unit. Pre-assembling is preferably made in such a way that the working cylinder according to the invention can be removed in a ready condition after process step c), i.e., welding. This step can be followed by process steps such as processing the outer surface, in particular the application of a varnish.

In process step b), the cylinder tube and the closure parts of the pre-assembly group are temporarily fixed and thus their positional relationship relative to each other is determined. In this process step, the relative positional relationship of the cylinder tube and closure parts corresponds to the relative positional relationship of these components in the completely finished working cylinder.

Thus, the closure parts are preferably designed such that they are guided by an applied force along the main longitudinal axis of the cylinder tube in their end position to the cylinder and fixed there. This is preferably achieved by means of a cylindrical section that is inserted into the cylinder tube with an exact fit, as well as by means of an appropriate design of the axial contact surfaces of the closure parts.

Application of a force acting along the main longitudinal axis of the cylinder tube is preferably achieved by clamping it in a jaw chuck and opposite in a tail spindle (or similar fixing elements) of a machine. Preferably, working cylinders to be manufactured with a high slenderness ratio are additionally guided by a steady rest.

With this device, the pre-assembly group can preferably be rotated around the main longitudinal axis of the cylinder tube. However, temporary fixations are also possible which do not envisage a rotation of the pre-assembly group.

In process step c), the cylinder tube is welded to the two closure parts of the pre-assembly group. According to the invention, this process step is carried out by laser welding.

During welding, the pre-assembly group is preferably rotated around the main longitudinal axis of the cylinder tube. The laser emitters are arranged stationarily around the pre-assembly group. In another variant of this process step, the pre-assembly group is arranged stationarily and the laser emitters are actively moved around the pre-assembly group to produce the laser ring weld seams. Preferably, axial force application is maintained during the entire process step c) so that distortion of the coupling partners to each other due to thermal stresses is advantageously prevented.

In both variants, a first laser ring weld seam is produced between the first closure part and the cylinder tube and a second laser ring weld seam between the second closure part and the cylinder tube.

The two laser ring weld seams connect the respective coupling partners of the pre-assembly group in a material-bonding and irreversible manner. In this context, irreversible means that non-destructive loosening of the connection is not possible.

The first laser ring weld seam and the second laser ring weld seam can be produced one after the other or simultaneously by means of several laser heads. The welding work is preferably carried out by a fully automatic welding robot in a laser welding system.

The welding system preferably operates under inert gas or under partial vacuum.

The production process is in particular characterized in that there is no longer any access to the cylinder interior after process step c). If a closure part is welded to the cylinder tube according to the state of the art, there is a problem of scaling on the inner surface sections of the corresponding closure part and of the cylinder tube, i.e., the surface sections of the cylinder interior to be formed, which must be removed again in a further work step. Furthermore, according to the prior art, the seal and the guide, for example, can only be inserted into a first closure part designed as a guide closure part after cooling has been completed, because otherwise they would be thermally damaged.

The production method disclosed in the invention shows a solution according to which welding is possible even with inserted thermally sensitive components, such as the seal and guide, and subsequent access to the inner surface sections is not possible and there is no need to clean them.

It was surprisingly found that laser welding with a small weld seam width, with a small amount of introduced thermal energy per weld length (energy input per unit length) and in combination with a high welding speed, high temperature gradients in the pre-assembly group can be achieved so that a high proportion of the thermal energy can be dissipated again directly via the surface surrounding the weld seam and, at the same time, the temperature on the inner surfaces and on the thermally sensitive components, such as seals and guides, can be kept so low that neither scaling of the inner surfaces nor thermal damage to the thermally sensitive components occurs. In addition, thermal stresses in the coupling partners are considerably reduced. Surprisingly, this solution provides a production process that has not been possible so far and allows the manufacture of a completely welded differential working cylinder, wherein the process step of welding can furthermore be carried out simultaneously for both closure parts.

The advantage of the process according to the invention are great savings in production time because machining of the cylinder tube can be omitted. Moreover, only the production process according to the invention makes it possible to form the cylinder tube with a significantly smaller tube wall thickness than it is the case with working cylinders of the state of the art coupled in a positive-locking manner. The parts of the description relating to the advantages of the working cylinder according to the invention also apply correspondingly to the advantages of the production process.

Thus, the laser welding process has the advantage that the energy has a highly locally restricted effect on the components of the pre-assembly group. Therefore, a smaller amount of energy is required for a ring weld seam, which also leads to an advantageously lower heat input.

Due to the high precision of the lasers, they can be aligned very precisely. The emission direction of the laser preferably runs along the planned laser ring weld seam center axis, which in turn preferably runs along the contact surfaces of the coupling partners of the pre-assembly group.

The wavelength, power and operating speed of the laser are adjusted to weld the material of the working cylinder.

According to an advantageous further development, the method according to the invention relates to the production of a differential working cylinder. In this further development, the process is characterized in that in process step a) joining is carried out in the following manner. The cylinder tube, the first closure part designed as a guide closure part, the second closure part designed as a bottom closure part and the piston unit consisting of the piston and the piston rod are joined to form a pre-assembly group of a differential working cylinder. Joining is carried out in such a way that the piston rod slidably passes through the first closure part, which is a guide closure part here.

According to another further development, the method relates to the production of a synchronized cylinder, also referred to as a steering cylinder. In line with this further development, the method is characterized in that in process step a) joining of the cylinder tube, the first closure part formed as a guide closure part, the second closure part formed as a further guide closure part and the piston unit consisting of the piston and the piston rod is carried out to form a pre-assembly group of a synchronized cylinder. Joining is carried out in such a way that the piston rod slidably passes through both closure parts.

According to a next further development, the production process according to the invention is carried out in such a way that a plunger cylinder is manufactured. For this purpose, in process step a), joining is carried out as follows. The cylinder tube, the first closure part designed as a guide closure, the second closure part designed as a bottom closure part and the piston unit designed as a plunger are joined to form a pre-assembly group of a plunger cylinder. And the plunger passes through the first closure part, which is designed as a guide closure part.

According to an advantageous further development, in process step c) laser welding for producing the laser ring weld seams is carried out with a ring weld inclination angle alpha of between 20 and 70 degrees. Here, the laser head is guided at this angle relative to the pre-assembly group. This leads to a laser ring weld seam that is inclined at this ring weld seam inclination angle.

According to another advantageous further development, in process step c) laser welding for producing the laser ring weld seams is carried out with a ring weld seam inclination angle alpha of between 110 and 160 degrees. For this purpose, at least one of the two closure parts is first provided with an axially open circumferential concave receiving contour in preparation for step a), which applies to joining. During joining according to step a), the correspondingly designed cylinder tube end is then inserted into the receiving contour, wherein automatic centring is performed due to the corresponding design, leading to the advantageously further increased precision.

In process step c), the laser head is guided at this angle relative to the pre-assembly group. This results in a laser ring weld seam inclined at this ring weld seam inclination angle. The wedge-shaped joint is maintained under axial force during the complete process step c) so that distortion during laser welding due to thermal stresses, which are largely reduced but cannot be completely excluded, is avoided and thus a particularly precise and positionally accurate laser welded joint of the coupling partners is achieved.

According to another advantageous further development, the process step c) is carried out in such a way that at least one of the laser ring weld seams is produced axially on the front face side and the ring weld seam inclination angle alpha is 180 degrees. For this purpose, the laser beam is aligned parallel to the main longitudinal axis of the working cylinder in process step c).

In process step a), joining is carried out, wherein the exact axial distance between the two closure parts is adjusted. This step is based on the fact that the at least one closure part has no radial projection that would determine the axial positional relationship of the two coupling partners.

In accordance with other advantageous further embodiments, the process steps a) to c) are further applied to at least one fastening module in the process for producing a working cylinder.

A fastening module is understood to be a component for transmitting force from the differential cylinder to components of an application device. In a commonly used design, the fastening module has a bore hole—often also referred to as an eye—into which a locking element, such as a bolt, can be inserted. The locking element connects the fastening module on the piston rod side to a component of an application device in a positive-locking manner and ensures the transmission of force during operation. In particular, the fastening module can be designed as a spherical bearing.

Preferably, the at least one fastening module is the piston-rod-side fastening module. A fastening module which is referred to as a piston-rod-side fastening module is arranged on the piston rod side. Furthermore, a bottom-side fastening module may also or alternatively be provided. A bottom-side fastening module is a fastening module that is arranged on the second closure part designed as a bottom closure part. However, it is also possible that the second closure part, if it is a bottom closure part, is configured to comprise the fastening module in such a manner that the fastening module is merely a portion of a monolithic bottom closure part.

The at least one fastening module is made of a weldable material, preferably metal.

In a first variant of the further development, the fastening module is a piston-rod-side fastening module. In a second variant of this further development, the fastening module is a bottom-side fastening module

In process step a), the joining step is further carried out here as a joining of a piston-rod-side fastening module to the corresponding component of the pre-assembly group. The pre-assembly group formed in this way is hereinafter referred to as an extended pre-assembly group.

In process step a), a piston-rod-side fastening module is arranged on the piston rod of the piston unit at its part protruding out of the cylinder tube. A bottom-side fastening module is arranged on the second closure part, which is designed as a bottom closure part.

According to this advantageous further development, the defined positional relationship of the respective fastening module to the corresponding component is established in process step b).

The fastening module is fixed temporarily and relative to the corresponding component of the pre-assembly group. The temporary fixation is carried out analogously to the methods already described. However, additional means of fixation may also be provided.

According to the first variant of this advantageous further embodiment, welding of the piston-rod-side fastening module produces a first fastening module weld seam in process step c).

The piston-rod-side fastening module is welded to the piston rod in process step c). This is preferably done analogously to the welding process carried out for the remaining components of the extended pre-assembly group. The produced first fastening module weld seam connects the piston-rod-side fastening module to the piston rod.

According to the second variant of the same further development, welding of the bottom closure part to the bottom-side fastening module produces a second fastening module weld seam in process step c).

This is done analogously to the welding process carried out for the piston-rod-side fastening module. The second fastening module weld seam connects the bottom-side fastening module to the bottom closure part.

The invention is described as an exemplary embodiment in more detail by means of the following figures. They show:

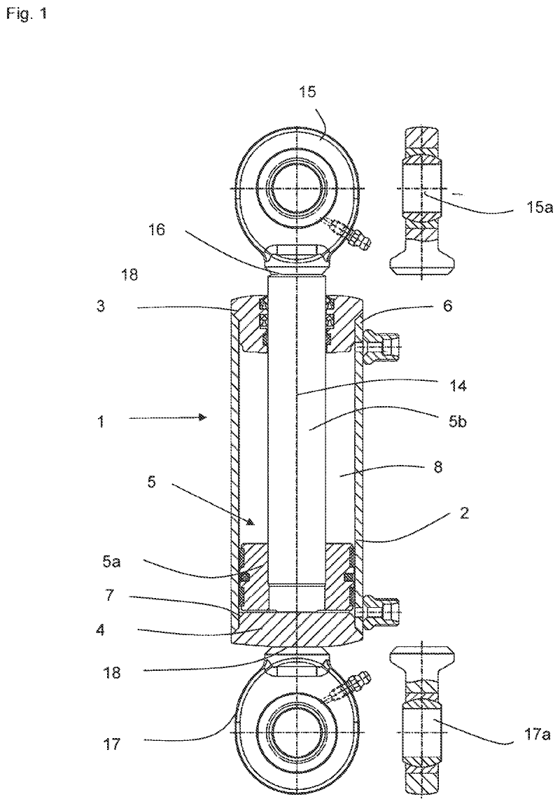

FIG. 1 Differential working cylinder (overview)

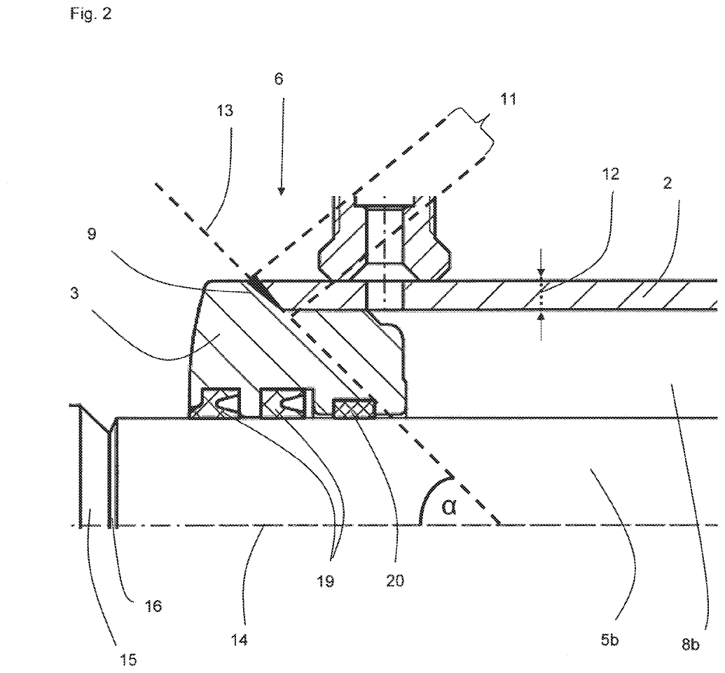

FIG. 2 Enlarged detail at the guide-side cylinder tube end

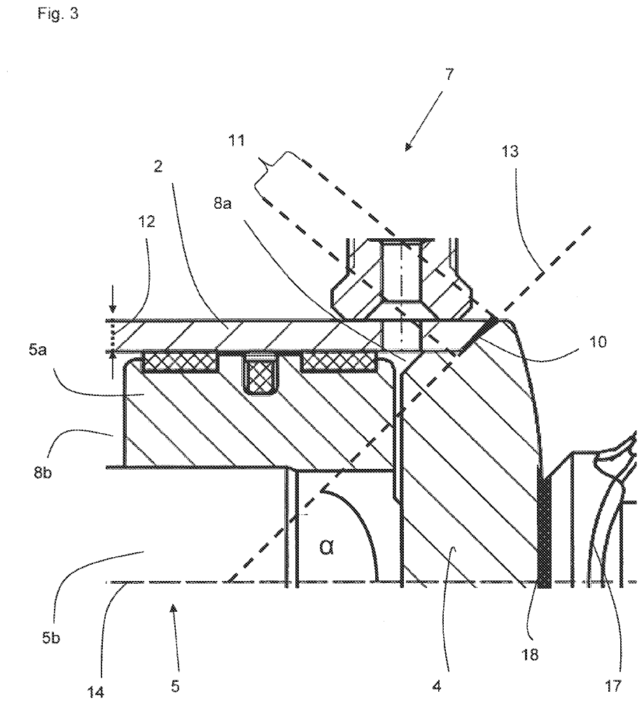

FIG. 3 Enlarged detail at the bottom-side cylinder tube end

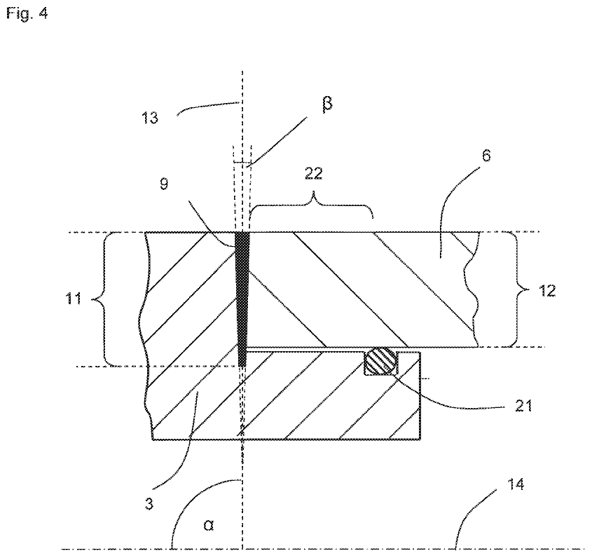

FIG. 4 Enlarged view of a laser weld seam to show the cross-section and the ring weld seam angle beta

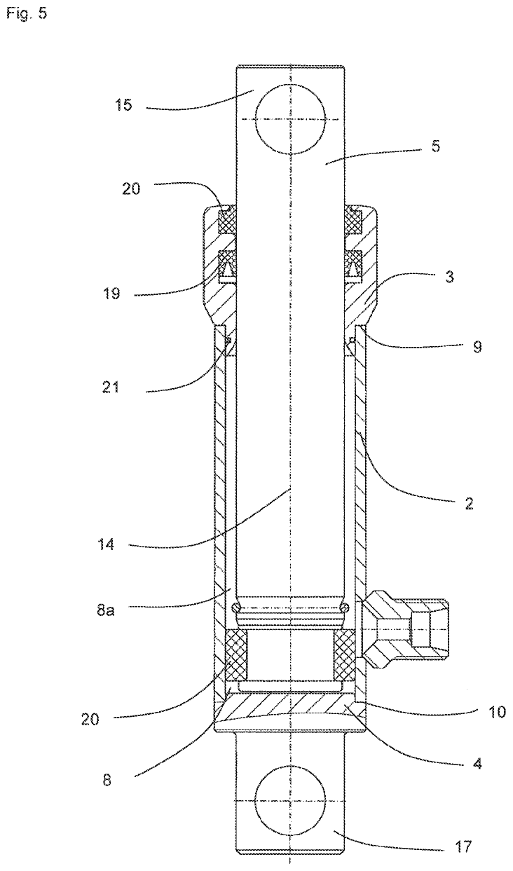

FIG. 5 plunger cylinder with 90-degree weld seam and upstream O-ring

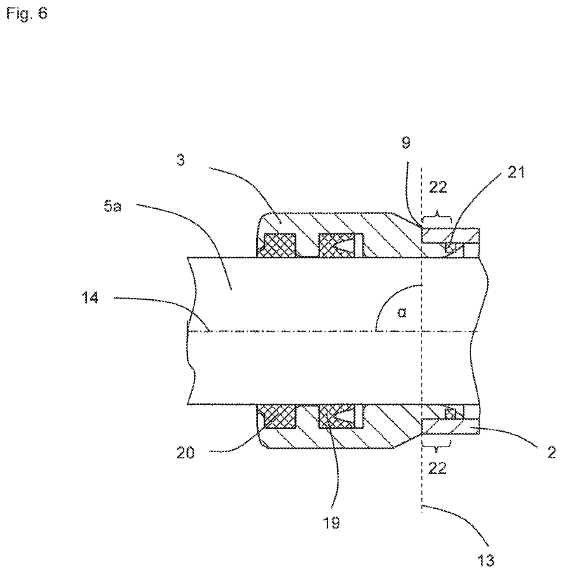

FIG. 6 Enlarged detail to FIG. 5 to show the O-ring and the annular section

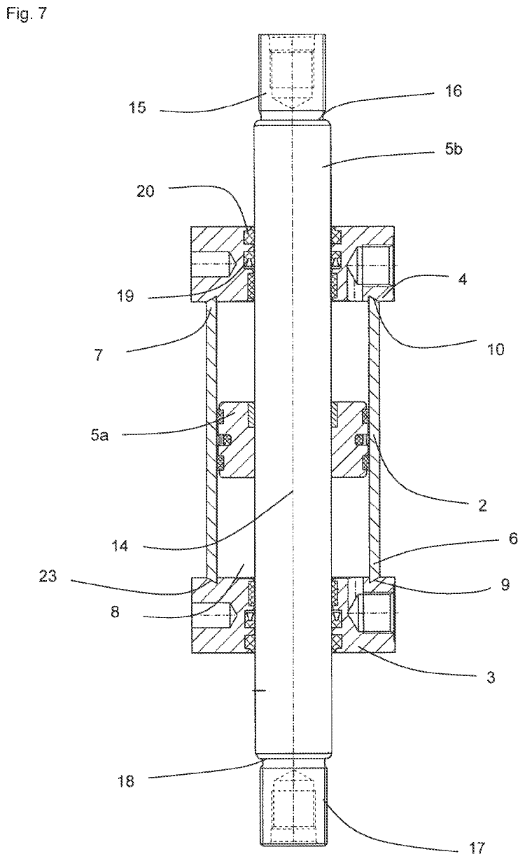

FIG. 7 Synchronized cylinder with negative-obliquely inclined weld seam

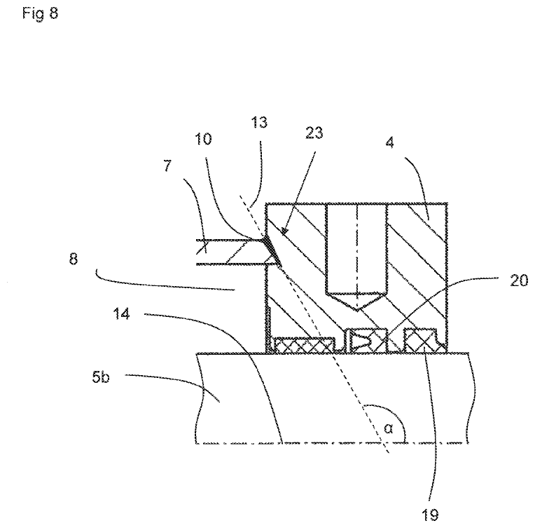

FIG. 8 Enlarged detail to FIG. 7 to show the concave receiving contour

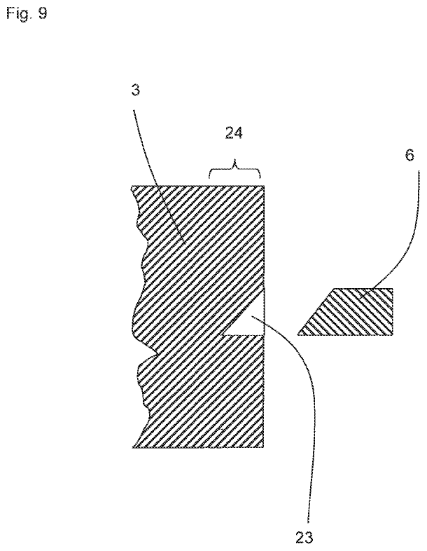

FIG. 9 Enlarged detail to FIG. 7 in exploded view

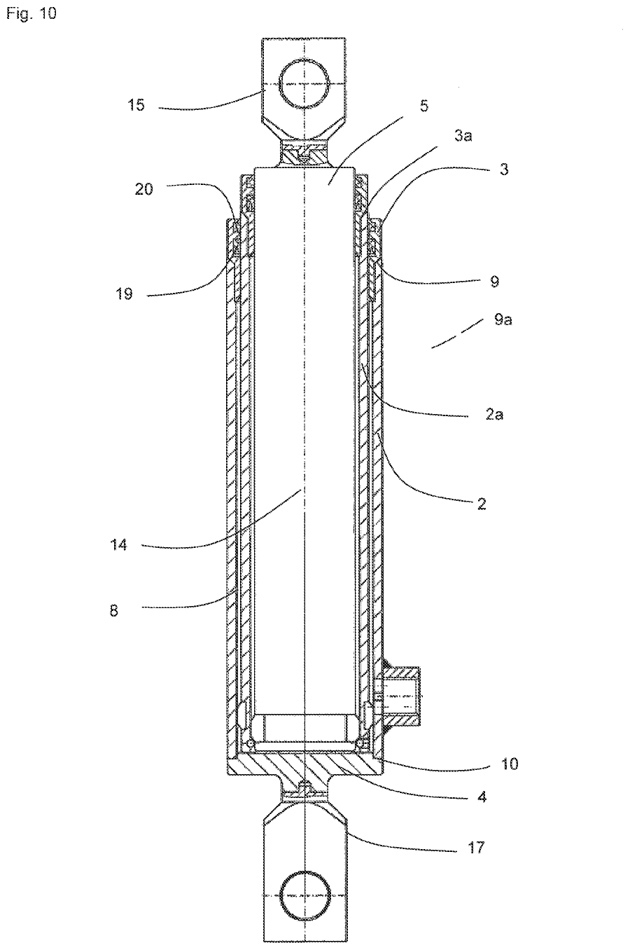

FIG. 10 Telescopic cylinder with combination of 90-degree weld seam and oblique seam

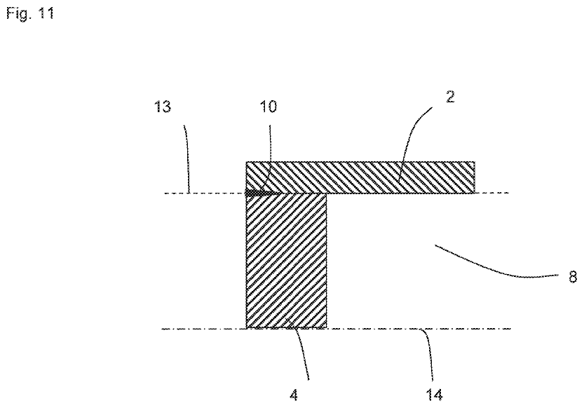

FIG. 11 Schematic representation of a bottom closure part with 0-degree weld seam.

FIG. 1 shows an overview of an embodiment of the working cylinder 1 designed as a differential working cylinder. The differential working cylinder 1 comprises the cylinder tube 2, the first closure part 3, here designed as a guide closure part, the second closure part 4, here designed as a bottom closure part, and the piston unit 5. The piston unit consists of the piston 5a and the piston rod 5b.

In this embodiment, the piston-rod-side fastening module 15 is arranged at the piston rod 5b and the bottom-side fastening module 17 is arranged on the second closure part 4 designed as a bottom closure part. Fastening bolts 15a, 17a, which are not elements of the invention and are shown merely for the sake of clarity, are assigned to each of the two fastening modules 15, 17.

The piston unit 5 is arranged in relation to the piston 5a and with sections of the piston rod 5b in the cylinder interior 8, and the piston rod 5b slidably passes through the first closure part 3 designed as a guide closure part.

The first closure part 3, designed as a guide closure part, closes the cylinder tube 2 at the first cylinder tube end 6, here the guide-side cylinder tube end, and the second closure part 4, designed as a bottom closure part, closes the second cylinder tube end 7, here the bottom-side cylinder tube end.

The two cylinder tube ends 6, 7 are bevelled and, consequently, have a larger contact surface with the two closure parts 3, 4. In this embodiment, the two closure parts 3, 4 are designed such that they project with a cylindrical section partially and precisely fitting into the cylinder tube and can thus be joined more easily to the pre-assembly group.

The main longitudinal axis 14 of the cylinder tube 2 runs centrally and longitudinally through the working cylinder 1.

FIG. 2 shows an enlarged detail of the area of the first cylinder tube end 6. This is the cylinder tube end on the guide side. Here, the geometric conditions of the first circumferential laser ring weld seam 9 are shown in particular. During welding, the first circumferential laser ring weld seam 9 is produced by a laser along the ring weld seam center axis 13 in this embodiment. This seam runs along the contact surface between the first cylinder tube end 6 and the first closure part 3. For this purpose, the previously assembled and temporarily fixed pre-assembly group consisting of the cylinder tube 2, the first closure part 3, the second closure part 4, the piston unit 5 and the two fastening modules 15, 17 is rotated around the main longitudinal axis of the cylinder tube 14 and in front of the laser.

The ring weld seam center axis 13 runs centrally through the first circumferential laser ring weld seam 9 and includes the ring weld seam inclination angle alpha in its extension with the main longitudinal axis of the cylinder tube 14. The ring weld seam depth 11 is the length of the ring weld seam center axis 13 which runs in the actual laser ring weld seam 9. Due to the angulation, the ring weld seam depth 11 is greater than the cylinder tube wall thickness 12. The ring weld seam depth corresponds to the hypotenuse of a right-angled triangle formed by the ring weld seam, the cylinder tube wall thickness 12 and a perpendicular.

This representation also shows the first fastening module weld seam 16 between the piston-rod-side fastening module 15 and the piston rod 5b. It is produced by means of the same laser welding method that is applied for the first circumferential laser ring weld seam 9.

Furthermore, the sliding bearing of the piston rod 5b in the first closure part 3 designed as a guide closure part is also shown with guide 20 and seal 19.

FIG. 3 shows an enlarged view of a section of the bottom end of the cylinder tube, which is the second end of the cylinder tube 7.

The structure of the illustration mainly corresponds to FIG. 2. The connection of the second closure part 4, designed as a bottom closure part, to the second cylinder tube end 7 is established analogously to the connection of the first closure part 3, designed as a guide closure part, to the first cylinder tube end 6 (see FIG. 2) by means of a laser welding process. Here, the second laser ring weld seam 10 is formed.

In addition to FIG. 2, this illustration shows the piston 5a separating the cylinder interior 8 into a piston crown working chamber 8a and a piston rod working chamber 8b. Both working chambers 8a, 8b are separately supplied with a hydraulic pressure medium via the fluid connections, and the working cylinder 1 designed as a differential cylinder is operated in this way.

Analogous to the piston-rod-side fastening module 15 (see FIG. 2), the bottom-side fastening module 17 is also fastened by means of a laser weld seam, the second fastening module weld seam 18.

FIG. 4 shows an enlarged laser weld seam. The first laser weld seam 9, between the first cylinder tube end 2 and the first closure part 3, shown here is an exemplary laser weld seam according to the present invention.

This first laser weld seam 9 has a ring weld seam depth 11 and a ring weld seam center axis 13. In this embodiment, the ring weld seam depth 11 is greater than the cylinder tube wall thickness 12.

The laser weld seam has a slight conicity. If two tangents are put at the edge contour of the laser weld seam, they intersect and form a ring weld seam angle beta. The ring weld seam center axis 13 is also the bisecting line of the ring weld seam angle beta and, together with the main longitudinal axis 14, includes the ring weld seam inclination angle alpha. Furthermore, the ring weld seam center axis 13 runs along the contact surface of the first cylinder tube end 6 and the first closure part 3. In this embodiment, the ring weld seam inclination angle alpha is 90 degrees.

FIG. 5 shows an embodiment of a working cylinder which is designed as a plunger working cylinder. Here, the piston unit 5, which is designed as a plunger piston, is guided in the cylinder tube 2. In addition, the piston unit 5 is guided in the first closure part 3, which is designed as a guide closure part. For this purpose, the plunger cylinder is equipped with the guides 20. The guide closure part is connected to the cylinder tube 2 at its first cylinder tube end 6 by means of the first laser ring weld seam 9. Opposite the guide closure part, the second closure part 4, here designed as a bottom closure part, is connected to the cylinder tube 2 at the second cylinder tube end 7 by the second laser ring weld seam 10. In this embodiment, the two laser ring weld seams 9, 10 have a ring weld seam inclination angle of 90 degrees.

The reference numerals and descriptive contents given in FIG. 1 for a differential working cylinder apply in addition.

The plunger working cylinder in the embodiment according to FIG. 5 also comprises an additional first circumferential sealing ring 21 at the first closure part 3. This additional sealing ring 21 is also referred to as an O-ring and is arranged radially between the cylinder tube 2 and the first closure part 3 and provides a pressure-tight seal which separates the second circumferential laser ring weld seam 10 from the pressure medium in a pressure-tight manner.

In FIG. 6 the area of the sealing ring 21 (O-ring) at the first closure part 3 from FIG. 5 is shown in an enlarged view. The sealing ring 21 (O-ring) is shown here in more detail and is located in spatial proximity to the first circumferential laser ring weld seam 9. In this embodiment, the sealing ring 21 (O-ring) is made of an elastic polymer. The heat input during laser welding remains sufficiently low to avoid damaging of the sealing ring 21 (O-ring) despite its close proximity to the first laser ring weld seam 9. From an axial point of view, there is a pressure-separated annular section 22 between the sealing ring 21 (O-ring) and the first laser ring weld seam 9. In this pressure-separated annular section 22, the operating pressure of the pressure medium is not applied to the inside of the cylinder tube so that forces from the pressure medium do not act radially on the cylinder tube 2 in this area. Thus, the cylinder tube 2 is not subject to buckling forces in this area and the first laser ring weld seam 9 is relieved.

In this design, the ring weld seam center axis 13 runs perpendicular to the main longitudinal axis 14 of the working cylinder 1.

FIG. 7 shows a synchronized working cylinder with a negative-obliquely inclined weld seam. In the synchronized working cylinder, both closure parts 3, 4 are designed as guide closure parts. The piston 5a is arranged in the axially central area of the piston rod 5b, which is guided by both closure parts 3, 4.

In this embodiment, the two cylinder tube ends 6, 7 each are inserted into a concave receiving contour 23 in the two closure parts 3, 4 and welded there by means of the laser welding process. The laser ring weld seam 9, 10 is negative-obliquely inclined here, which means an opposite bevelling of the contact surfaces (in comparison to, for example, the embodiment of FIG. 1) of the closure part 3, 4 and the cylinder tube end 6, 7.

In FIG. 8, the embodiment of FIG. 7 is shown in more detail in an enlarged view.

Here, the second cylinder tube end 7 is already inserted into the wedge-shaped concave receiving contour 23 and welded to the second closure part 4 by means of the second circumferential laser ring weld seam 10.

The ring weld seam center axis 13 and the main longitudinal axis 14 include the ring weld seam inclination angle alpha.

Here, the ring weld seam angle alpha has an angle greater than 90 degrees, in the embodiment of about 120 degrees.

FIG. 9 shows a schematic exploded view of the coupling partners according to FIG. 8. FIG. 9 shows the first cylinder tube end 6 and the first closure part 3 with the wedge-shaped concave receiving contour 23 before joining. The concave receiving contour 23 is designed to receive the first cylinder tube end 6 and to form a common contact surface with it, on which the first laser ring weld seam 9 is then arranged. FIG. 9 shows that the concave receiving contour 23 opens axially in the direction of the cylinder tube 2. Radial buckling forces acting on the cylinder tube 2 from the inside are thus absorbed in a positive-locking manner by a radial overlap 24. This is the inclined section of the concave receiving contour 23.

FIG. 10 shows an embodiment of a telescopic working cylinder. Compared to the previously described cylinder types, the telescopic working cylinder has a further cylinder tube 2a, which is arranged in the cylinder tube 2, as well as a further closure part 3a. The first closure part 3 and the further closure part 3a are designed as guide closure parts. The further cylinder tube 2a is welded to the further closure part 3a via a further circumferential laser ring weld seam 9a.

In this embodiment, straight laser ring weld seams (ring weld inclination angle alpha=90 degrees) are also combined with oblique laser ring weld seams (ring weld angle alpha <90 degrees).

In this embodiment, the first circumferential laser ring weld seam 9 on the first closure part 3 and the further circumferential laser ring weld seam 9a on the further closure part 3a are designed as oblique laser weld seams, and the second circumferential laser ring weld seam 10 on the second closure part 10 is designed as a straight laser weld seam.

FIG. 11 is a schematic representation of a detail of an embodiment in which the second circumferential laser ring weld seam 10 runs parallel to the main longitudinal axis.

Here, the second closure part 4, designed as a bottom closure part, is radially enclosed by the second cylinder tube 2. In the embodiment, the second closure part 4 and the annular surface of the cylinder tube 2 form a common front face side. However, it is also possible that one of the coupling partners axially protrudes or is set back relative to the other coupling partner.

The ring weld seam center axis 13 does not intersect the main longitudinal axis 14. The ring weld seam inclination angle alpha is 0 degrees.

### LIST OF REFERENCE NUMERALS

1 working cylinder
2 cylinder tube
2a further cylinder tube
3 first closure part
3a further closure part
4 second closure part
5 piston unit
5a piston
5b piston rod
6 first cylinder tube end
7 second cylinder tube end
8 cylinder interior
8a piston crown working chamber
8b piston rod working chamber
9 first circumferential laser weld seam
10 second circumferential laser weld seam
11 ring weld seam depth
12 cylinder tube wall thickness
13 ring weld seam center axis
14 main longitudinal axis
15 piston-rod-side fastening module
15a fastening bolts of the piston-rod-side fastening module
16 first fastening module weld seam
17 bottom-side fastening module
17a fastening bolts of the des bottom-side fastening module
18 second fastening module weld seam
19 seal
20 guide
21 circumferential sealing ring
22 pressure-separated annular section
23 concave receiving contour
24 radial overlap
α ring weld seam inclination angle alpha
β ring weld seam angle beta

1-18. (canceled)

19. A working cylinder, comprising:
a cylinder tube, a first closure part, a second closure part and a piston unit;
said cylinder tube having a first cylinder tube end and a second cylinder tube end;
said first closure part being arranged at said first cylinder tube end and said second closure part being arranged at said second cylinder tube end, said cylinder tube and said first and second closure parts define a cylinder interior;
said piston unit defining at least one working chamber in said cylinder interior, said piston unit slidably passing through said first closure part;
said first closure part being joined to said cylinder tube in a material-locking manner by a first circumferential laser ring weld seam, said second closure part being joined to said cylinder tube in a material-locking manner by a second circumferential laser ring weld seam, and each of said laser ring weld seams defining a fluid-tight sealing plane;

20. The working cylinder according to claim 19, wherein said working cylinder is double-acting and is constructed as a differential working cylinder, said first closure part is constructed as a guide closure part and said second closure part is constructed as a bottom closure part, said first cylinder tube end is a guide-side cylinder tube end and said second cylinder tube end is a bottom-side cylinder tube end;
said piston unit includes a piston and a piston rod, said piston is arranged in said cylinder interior and separates said cylinder interior into a piston crown working chamber and a piston rod working chamber and said piston rod slidably passes through said guide closure part.

21. The working cylinder according to claim 19, wherein said working cylinder is double-acting and is constructed as a synchronized cylinder, said first closure part is constructed as a first guide closure part and said second closure part is constructed as a second guide closure part, said piston unit includes a piston and a piston rod, said piston is arranged in said cylinder interior and separates said cylinder interior into a first piston rod working chamber and a second piston rod working chamber, and said piston rod slidably passes through said guide closure part and said second guide closure part.

22. The working cylinder according to claim 19, wherein said working cylinder is single-acting and is constructed as a plunger cylinder, said first closure part is constructed as a guide closure part and said second closure part is constructed as a bottom closure part, said first cylinder tube end is a guide-side cylinder tube end and said second cylinder tube end is a bottom-side cylinder tube end, said piston unit is a plunger piston with a plunger, said plunger is arranged in said cylinder interior and defines a working chamber in said cylinder interior, and said plunger slidably passes through said guide closure part.

23. The working cylinder according to claim 19, wherein a first circumferential sealing ring is arranged at an axial distance from said first laser ring weld seam in said cylinder interior between said first closure part and a cylinder tube inner wall of said cylinder tube at said first cylinder tube end, said sealing ring defines a first pressure-separated annular section between said first circumferential sealing ring and said first laser ring weld seam, and/or a second circumferential sealing ring is arranged at an axial distance from said second laser ring weld seam in said cylinder interior between said second closure part and said cylinder tube inner wall at said second cylinder tube end, and said second circumferential sealing ring defines a second pressure-separated annular section arranged between said second circumferential sealing ring and said second laser ring weld seam.

24. The working cylinder according to claim 19, wherein each of said laser ring weld seams has a ring weld seam depth, said ring weld seam depth has a ratio of 1.1 to 2.5 relative to a cylinder tube wall thickness.

25. The working cylinder according to claim 19, wherein each of said laser ring weld seams has a ring weld seam center axis, said ring weld seam center axis and a main longitudinal axis of said cylinder tube include a ring weld seam inclination angle of 20 to 70 degrees.

26. The working cylinder according to claim 19, wherein at least one closure part has an axial opening that is a circumferential concave receiving contour in which said cylinder tube engages, said receiving contour radially overlaps said cylinder tube, and a ring weld seam inclination angle thereof is 110 to 160 degrees.

27. The working cylinder according to claim 19, wherein at least one of the laser ring weld seams is arranged axially at a front face side of said cylinder tube and the ring weld seam is parallel to a longitudinal axis of said cylinder tube.

28. A method of producing a working cylinder, according to claim 19, comprising:
a) joining the cylinder tube, the first closure part, the second closure part and the piston unit to a pre-assembly group;
b) establishing a fixed relative positional relationship between the cylinder tube, the first closure part and the second closure part;
c) performing laser welding of the cylinder tube to the first closure part by producing the first laser ring weld seam and to the second closure part by producing the second laser ring weld seam.

29. The method for producing a working cylinder according to claim 28, wherein in joining process step a) the first closure part is provided as a guide closure part, the second closure part is provided as a bottom closure part and the piston unit is defined by a piston and a piston rod that slidably passes through the first closure part, to define a pre-assembly group of a differential working cylinder.

30. Method for producing a working cylinder according to claim 28, wherein for the joining process step a) the first closure part is constructed as a guide closure part, the second closure part is constructed as a further guide closure part and the piston unit is defined by a piston and a piston rod that slidably passes through both closure parts to define a preassembly of a synchronous cylinder.

31. Method for producing a working cylinder according to claim 28, wherein for the joining process step a) the first closure part is provided as a guide closure part, the second closure part is provided as a bottom closure part and the piston unit is provided as a plunger piston to define a pre-assembly group of a plunger cylinder.

32. The method for producing a working cylinder according to claim 28, wherein in the laser welding process step c) the laser ring weld seams have a ring weld seam inclination angle of 20 to 70 degrees.

33. The method for producing a working cylinder, according to claim 28, wherein in the laser welding process step c) is carried out with a ring weld seam inclination angle of 110 to 160 degrees.

34. The method for producing a working cylinder, according to claim 33, wherein in step c) is carried out axially on the front face side.

35. The method for producing a working cylinder according to claim 28, wherein:
in step a) joining is carried out by joining further a piston-rod-side fastening module to the pre-assembly group;
in step b) the fixed relative positional relationship of the rod-side fastening module is established; and
in step c), welding of a piston rod to the piston-rod-side fastening module is performed by producing a first fastening-module weld seam.

36. The method for producing a working cylinder according to claim 28, wherein:
in step a) joining is carried out by joining further a bottom-side fastening module to the pre-assembly group;
in step b) the fixed relative positional relationship of the bottom-side fastening module is established; and
in step c) the welding of the second closure part to the bottom-side fastening module is performed by producing a second fastening module weld seam.
